(19) United States
(12) Patent Application Publication
(10) Pub. No.: US 2015/0036059 A1
(43) Pub. Date: Feb. 5, 2015

(54) VIDEO DISPLAY DEVICE

(71) Applicants: Kabushiki Kaisha Toshiba, Tokyo (JP); Toshiba Lifestyle Products & Services Corporation, Tokyo (JP)

(72) Inventors: Yoshiharu MOMONOI, Yokohama (JP); Tatsuo SAISHU, Tokyo (JP)

(21) Appl. No.: 14/459,223

(22) Filed: Aug. 13, 2014

Related U.S. Application Data
(63) Continuation of application No. PCT/JP2013/070812, filed on Jul. 31, 2013.

(51) Int. Cl. H04N 5/655

(52) U.S. Cl. CPC H04N 5/655
USPC 348/836

(57) ABSTRACT

According to one embodiment, a video display device includes a display, an optical element, and a spacer member. The display has a video display section and a frame section. The optical element is provided so as to cover the frame section and an outer edge area provided on an outer edge side within the video display section. The spacer member is provided between the video display section and the optical member and between the frame section and the optical element. The spacer member has an inner surface positioned between the frame section and the optical element. The inner surface is provided with a first inclined surface inclined toward the frame section more on the video display section side than on the optical element side.

### CROSS-REFERENCE TO RELATED APPLICATIONS

This application is a continuation of international application No. PCT/JP2013/070812, filed Jul. 31, 2013, which designates the United States, the entire contents of which are incorporated herein by reference.

### FIELD

Embodiments described herein relate generally to a video display device.

### BACKGROUND

Conventionally, there has been known a technique to prevent viewers from visually recognizing outer frames of a display by enlarging video on the display using optical elements provided so as to correspond to the outer frames. In such a technique, a spacer member can be provided so as to fill a distance between the display (and the outer frames), and the optical elements.

In a technique such as that described above, it is desirable to prevent the spacer member from being visually recognized by the viewers.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic view illustrating one example of a tiling display configured by combining a plurality of video display devices with each other, according to an embodiment;

FIG. 2 is an exemplary schematic view for explaining directions in which video is enlarged by a linear lens (optical element) in the video display device, in the embodiment;

FIG. 3 is an exemplary schematic view for explaining directions in which video is enlarged by a circular lens (optical element) in the video display device, in the embodiment;

FIG. 4 is an exemplary schematic view for explaining a positional relation among a display section, a frame section, an optical element, and a spacer member of the video display device, in the embodiment;

FIG. 5 is an exemplary schematic view for explaining how video output from the video display device is viewed, in the embodiment;

FIG. 6 is an exemplary schematic view illustrating one example of the video display device from which the optical element is removed, in the embodiment;

FIG. 7 is an exemplary view illustrating one example of a configuration of a first spacer member of the video display device, in the embodiment;

FIG. 8 is an exemplary cross-sectional view taken along line 51-51 of FIG. 7, in the embodiment;

FIG. 9 is an exemplary cross-sectional view taken along line 52-52 of FIG. 7, in the embodiment;

FIG. 10 is an exemplary view illustrating one example of a configuration of a second spacer member of the video display device, in the embodiment;

FIG. 11 is an exemplary cross-sectional view taken along line 53-53 of FIG. 10, in the embodiment;

FIG. 12 is an exemplary cross-sectional view taken along line 54-54 of FIG. 10, in the embodiment;

FIG. 13 is an exemplary schematic view illustrating one example of a tiling display configured by combining a plurality of video display devices with each other, according to a first modification; and

FIG. 14 is an exemplary schematic view illustrating one example of an optical element of the video display device, according to a second modification.

### DETAILED DESCRIPTION

In general, according to one embodiment, a video display device comprises a display, an optical element, and a spacer member. The display comprises a video display section and a frame section. The video display section is configured such that video is displayed thereon. The frame section is provided along an outer edge of the display section. The optical element is provided so as to cover the frame section and an outer edge area provided on the outer edge side within the video display section. The optical element is configured to enlarge video output from the outer edge area onto the frame section side. The spacer member is provided between the video display section and the optical member and between the frame section and the optical element. The spacer member comprises an inner surface positioned between the optical element and the video display section. The inner surface is provided with a first inclined surface inclined toward the frame section more on the video display section side than on the optical element side.

Embodiments will be described below with reference to the accompanying drawings.

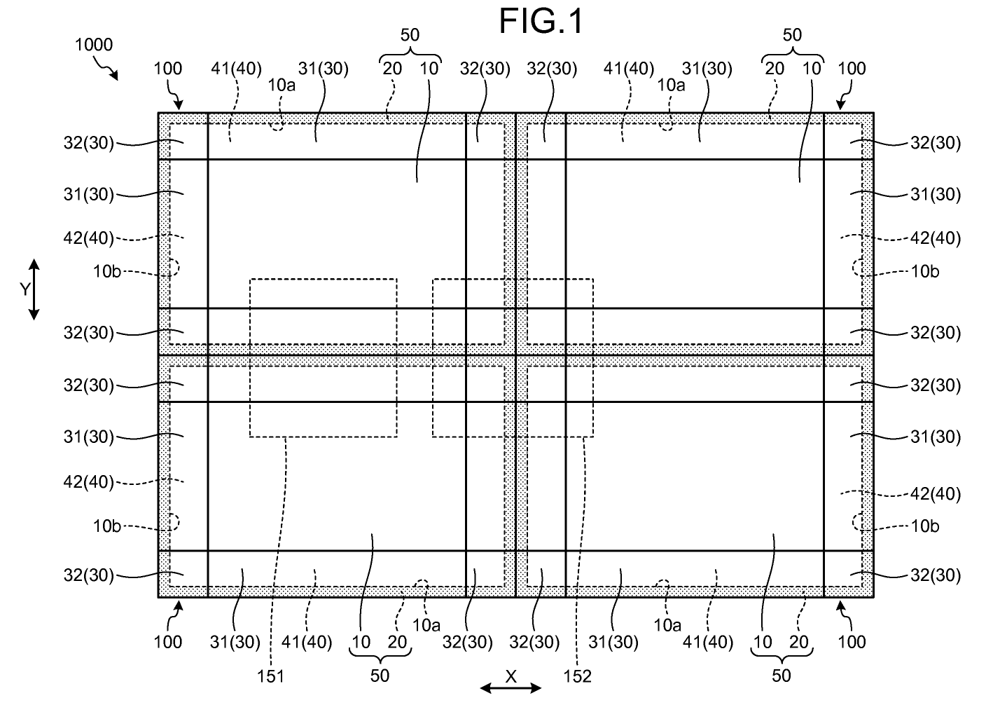

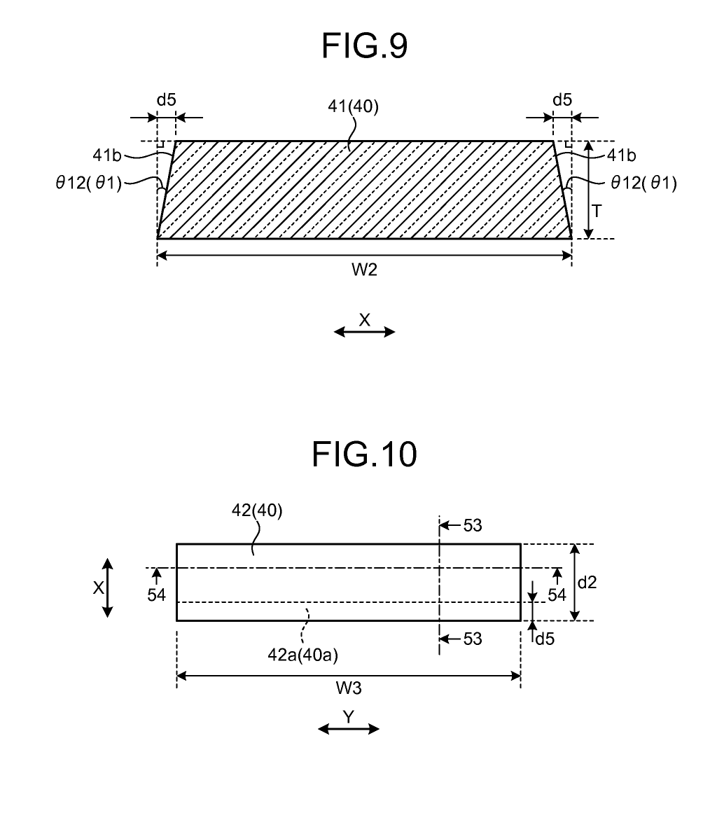

With reference to FIGS. 1 to 12, the following first describes an exemplary configuration of a video display system (a tiling display 1000) comprising a plurality of video display devices 100 combined with each other, according to an embodiment.

As illustrated in FIG. 1, the tiling display 1000 in the embodiment comprises four video display devices 100, two each being arranged in the horizontal direction (the X direction) and the vertical direction (the Y direction) in a tile pattern. The four video display devices 100 each comprise a video display section 10, a frame section 20, an optical element 30, and a spacer member 40. The video display section 10 is formed in a quadrilateral shape (a rectangular shape) having a long side (a first side) 10a extending in the X direction (a first direction) and a short side (a second side) 10b extending in the Y direction (a second direction). The video display section 10 is configured to output video, such as a moving image or a still image. The frame section 20 is provided so as to surround an outer periphery (an outer edge: portion composed of the long sides 10a and the short sides 10b) (see the dot-shaded portions in FIG. 1) and to extend along the long sides 10a and the short sides 10b of the video display section 10. The video display section 10 and the frame section 20 constitute a display (a display panel) 50.

In the video display device 100 comprising the video display section 10 and the frame section 20 as described above, it is desired to prevent the frame section 20 from being viewed by a viewer. For example, when a single large piece of video is displayed using the tiling display 1000 as illustrated in FIG. 1, it is desired to prevent a cross-shaped joint and a quadrilateral outer frame from being viewed by the viewer. The cross-shaped joint is composed of the frame sections 20 provided on the inside of the tiling display 1000 (boundaries of the video display devices 100). The quadrilateral outer frame is composed of the frame sections 20 provided on the outside of the entire tiling display 1000.

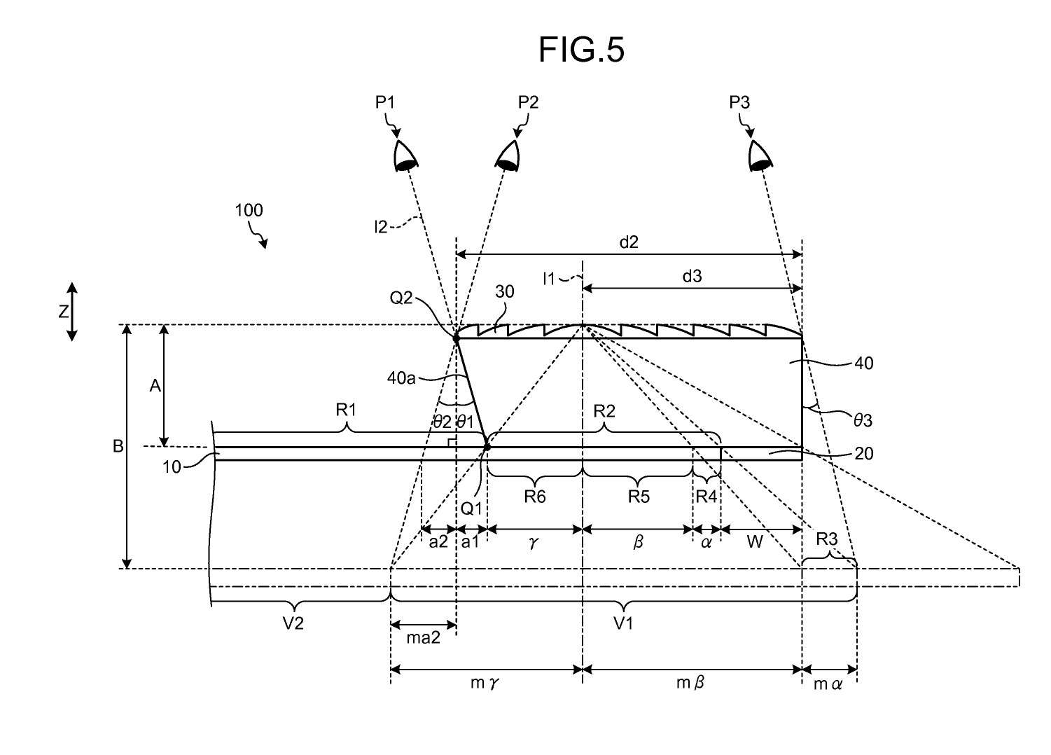

Thus, the embodiment comprises the optical element 30 that covers an outer peripheral area (an outer edge area: see a reduction area R2 to be described later with reference to FIG. 5) and the frame section 20. The outer peripheral area is provided on the outer periphery (the outer edge: a boundary relative to the frame section 20) side within the video display section 10. The embodiment then uses the optical element 30 to enlarge the video output from the outer peripheral area, thereby preventing the frame section 20 from being viewed by the viewer. This enables the tiling display 1000 comprising the four video display devices 100 to function as a continuous single display. In the embodiment, the video display section 10 is configured to output to the outer peripheral area video reduced at a reduction ratio compatible with a magnification of the optical element 30. The optical element 30 is configured to enlarge the video (reduced video) output from the outer peripheral area of the video display section 10 to at least the frame section 20 side.

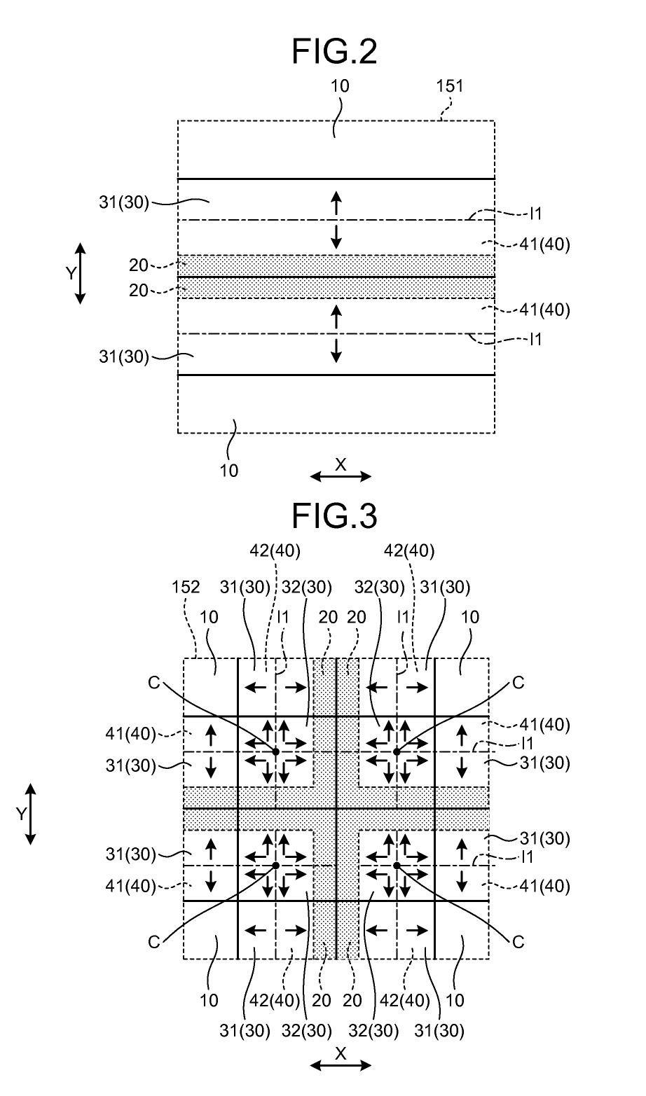

Specifically, the optical element 30 comprises linear lenses 31 and circular lenses 32 combined with each other. The linear lenses 31 each extend along the corresponding one of the four sides of the video display section 10 and have, for example, a rectangular shape. The circular lenses 32 are each provided at the corresponding one of the four corners of the video display section 10 and each have, for example, a rectangular shape or a square shape. The linear lenses 31 are each configured to enlarge the video output from the outer peripheral area of the video display section 10 in only one direction of the X direction or the Y direction (see the arrows in FIG. 2). The circular lenses 32 are each configured to enlarge the video output from the outer peripheral area of the video display section 10 in two directions of the X direction and the Y direction (see the arrows in FIG. 3).

More specifically, as illustrated in FIG. 2, the linear lens 31 has an optical axis I1 that extends along a side of the video display section 10. The linear lens 31 is configured to enlarge the video output from the outer peripheral area line-symmetrically with respect to the optical axis I1. It is noted that FIG. 2 is a schematic enlarged view of a quadrilateral portion 151 located on one side in the X direction (the left side in FIG. 1) and near a central portion in the Y direction of the tiling display 1000 illustrated in FIG. 1.

Similarly, as illustrated in FIG. 3, the circular lens 32 has a center C at which two optical axes 11 associated with two adjacent linear lenses 31 cross each other. The circular lens 32 is configured to enlarge the video output from the outer peripheral area point-symmetrically with respect to the center C. It is noted that FIG. 3 is a schematic enlarged view of a quadrilateral portion 152 located near a central portion in the X direction and the Y direction of the tiling display 1000 illustrated in FIG. 1.

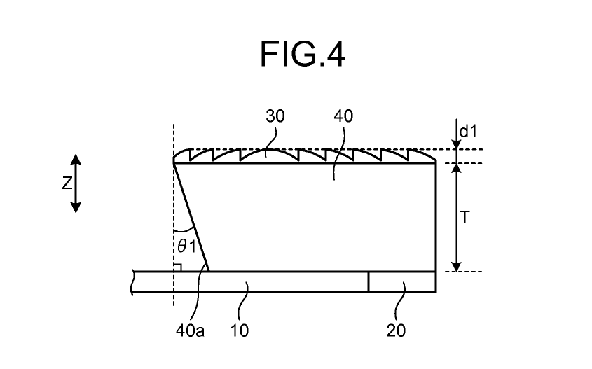

It is here to be noted that, in the embodiment, the optical element 30 (the linear lenses 31 and the circular lenses 32) is provided so as to extend in parallel with the video display section 10. More specifically, the linear lens 31 comprises Fresnel-shaped lenses notched line-symmetrically with respect to the optical axis I1 (see FIG. 2). Similarly, the circular lens 32 comprises Fresnel-shaped lenses notched point-symmetrically (concentrically) with respect to the center C (see FIG. 3). Using the Fresnel-shaped lenses as described above for the optical element 30 exemplarily allows a thickness d1 (see FIG. 4) of the optical element 30 to be made smaller than in ordinary convex lenses.

In the embodiment, as illustrated in FIGS. 4 and 5, the spacer member 40 is provided between the video display section 10 and the frame section 20, and the optical element 30. The spacer member 40 is provided for maintaining a predetermined distance between the video display section 10 (the frame section 20) and the optical element 30. The spacer member 40 is formed of a transparent material.

As illustrated in FIGS. 4 and 5, the spacer member 40 has a first inclined surface 40a on an inner surface positioned between the optical element 30 and the video display section 10 (the surface on the side opposite to the frame section 20). The first inclined surface 40a is inclined toward the frame section 20 side more on the video display section 10 side than on the optical element 30 side. It is here noted that, in the embodiment, the first inclined surface 40a extends linearly, on the inner surface of the spacer member 40, from an end on the optical element 30 side (see a point Q2 in FIG. 5) to the other end on the video display section 10 side (see a point Q1 in FIG. 5). Specifically, the entire inner surface of the spacer member 40 is inclined. Thus, exemplarily, as compared with an arrangement in which only part of the inner surface of the spacer member 40 is inclined, the inner surface of the spacer member 40 can be more prevented from being visually recognized by the viewer.

In the embodiment, the first inclined surface 40a is provided so as to be inclined at an inclination angle θ1 and so as to be aligned with an optical path (see a straight line I2 in FIG. 5) connecting the points Q1 and Q2 in FIG. 5. The point Q2 in FIG. 5 is positioned at an end of the optical element 30 on the side opposite to the frame section 20 (the inner surface side of the spacer member 40). The point Q1 in FIG. 5 is positioned at an end of the outer peripheral area (see the reduction area R2 in FIG. 5 to be described later) of the video display section 10 on the side opposite to the frame section 20 (the inner surface side of the spacer member 40). The inclination angle θ1 is an inclination angle relative to a direction orthogonal to the video display section 10 and the optical element 30 (in the front-to-rear direction; the Z direction; more specifically, the direction extending from the optical element 30 toward the video display section 10). As a result, exemplarily, even when the viewer views the video display device 100 from a viewpoint along the optical path indicated by the straight line 12 (see FIG. 5), a line of sight of the viewer can be prevented from being blocked by the inner surface of the spacer member 40. Thus, the viewer can be prevented from having a sense of discomfort.

The following describes how video output from the video display device 100 in the embodiment is viewed with reference to FIG. 5. As illustrated in FIG. 5, the video display section 10 of the video display device 100 has a normal area R1 and the reduction area (outer peripheral area) R2. The normal area R1 outputs normal video that is neither enlarged nor reduced. The reduction area R2 outputs video reduced at a reduction ratio compatible with the magnification of the optical element 30 (reduced video). The dash-double-dot line in FIG. 5 represents video (virtual video) visually recognized by the viewer through the optical element 30.

As illustrated in FIG. 5, the optical element 30 (let m be the magnification) enlarges the reduced video output from the reduction area R2 as a virtual video V1 having a width larger than that of the optical element 30. In the embodiment, the reduction area R2 has a width (α+β+γ) smaller than an overall length d2 of the optical element 30. As a result, exemplarily, even when the viewer looks into the video display device 100 from a viewpoint P1, the viewer visually recognizes the normal video (the normal area R1), and not the reduced video (the reduction area R2). The viewpoint P1 is on the inside by the angle θ1 relative to an end on the inside of the optical element 30 (on the side opposite to the frame section 20). Thus, the viewer can be prevented from having a sense of discomfort.

Additionally, in the embodiment, the virtual video V1 corresponding to the reduction area R2 has a width (m×(α+β+γ) greater than the overall length d2 of the optical element 30. As a result, exemplarily, even when the viewer looks into the video display device 100 from a viewpoint P2, the viewer visually recognizes the video (the virtual video V1) that is enlarged reduced video (the reduction area R2), and not the video (virtual video V2) that is enlarged normal video (the normal area R1). The viewpoint P2 is on the outside by the angle θ2 relative to the end on the inside of the optical element 30 (on the side of the frame section 20). Thus, the viewer can be prevented from having a sense of discomfort.

Further, in the embodiment, the virtual video V1 has an area R3 that extends beyond an end on the outside (on the frame section 20 side) of the video display device 100. Overlapping video is output in a reduced condition to an area R4 that is part of the reduction area R2 and that corresponds to the area R3. The overlapping video overlaps video displayed near an end on the frame section 20 side of an adjoining video display device 100. The area R4 will hereinafter be referred to as an overlapping area. As a result, exemplarily, even when the viewer views the tiling display 1000 that comprises a plurality of video display devices 100 (see FIG. 1), the viewer can visually recognize the overlapping video in the area R3, which allows the viewer to be prevented from having a sense of discomfort in viewing the boundaries of the video display device 100. That is, exemplarily, even when the viewer views the video display device 100 from a viewpoint P3, he or she can visually recognize defect-free video. The viewpoint P3 is on the inside by an angle θ3 relative to the end on the outside of the optical element 30 (on the side opposite to the frame section 20).

The following describes in greater detail an exemplary optical system for allowing the viewer to visually recognize the defect-free video using expressions.

First, let d3 be the length of a portion of the optical element 30 outside (on the frame section 20 side relative to) the optical axis I1. Then, the magnification m of the optical element 30 is given by expression (1) below based on a length β of an area R5 that represents the area of the reduction area R2 outside the optical axis I1 less the overlapping area R4.

m=d3/β (1)

Let W be the width of the frame section 20 and α be the length of the overlapping area R4. Then, the length d3 is given by expression (2) below. The length d3 is provided for preventing the viewer from visually recognizing the frame section 20 (for causing the viewer to visually recognize the virtual video V1 that is to cover the optical element 30).

d3=β+α+W (2)

In this case, with a condition of d3=m×β, for example, satisfied, the frame section 20 is not visually recognized when, at least, viewed from the front side (one side in the Z direction; from above in FIG. 5). The embodiment has the overlapping area R4 with the length α, thereby the viewer to visually recognize the defect-free video, exemplarily, up to the viewpoint P3 that is on the inside by the angle θ3 relative to the end on the outside of the optical element 30 (on the side opposite to the frame section 20).

Let f be the focal distance of the optical element 30, a distance A is given by expression (3) below. The distance A is a distance between the video display section 10 and the optical element 30.

A=f((β/d3)−1)=f(1/m−1) (3)

In addition, a distance B at which the virtual video V1 is visually recognized is given by expression (4) below.

B=A(d3/β)=m×A (4)

In this case, the angle θ3 at which the overlapping area R4 is visually recognized is given by expression (5) below.

tan (θ3)=−(α/B)×(d3/β)=−(α/B)×m (5)

Assume here that a condition of |θ3|=|θ2|=|θ1| is satisfied. On this condition, a relation between a width a1 and a width a2 is given by expression (6) below. The width a1 is a width of a portion provided behind the optical element 30 of the normal area R1. The width a2 is a width of a portion adjacent to the portion having the width a1.

|a1|=|a2| (6)

A relation between the widths a1 and a2, and a length γ is given by expression (7) below. The length γ is a length of an area R6 that is the reduction area R2 on the inside (the side opposite to the frame section 20) of the optical axis I1.

|m|×γ=γ+a1+|m|×a2=γ+a1+|m|×a1 (7)

In addition, a relation of expression (8) below holds between the width a1 and the distance A.

|a1|=|A|×tan |θ1|=|A|×tan |θ3| (8)

From expression (7) and expression (8) above, expression (9) below can be derived.

γ=|A|×tan |θ3|×(1+|m|)/(|m|−1) (9)

The length γ of the area R6 that is the reduction area R2 on the inside of the optical axis I1 can be calculated using expression (9) above so as to allow the viewer to visually recognize the defect-free video when viewing the video display device 100 from the viewpoint P3 (P1, P2) at the angle θ3 (θ1, θ2).

The following describes in greater detail the inclination angle θ1 of the first inclined surface 40a of the spacer member 40, the angle allowing the first inclined surface 40a to be prevented from being visually recognized by the viewer.

In general, the high-definition television broadcasting standard has an aspect ratio of 16:9. With a video display device that displays video having the aspect ratio of 16:9, a standard distance between the viewer and the video display device is said to be three times as long as the width in the vertical direction of the video display device (specifically, what is called a 3H distance) . In this case, the angle of view in the horizontal direction is about ±16 degrees, while that in the vertical direction is about ±9 degrees.

Therefore, in the embodiment, it is necessary to set the abovementioned inclination angle θ1 to at least 9 degrees. Specifically, in a viewing environment complying with the full high-vision broadcasting standard, setting the inclination angle θ1 to at least 9 degrees or more allows the inner surface (the first inclined surface 40a) of the spacer member 40 to be less easily visually recognized, even if the viewer views video on the video display section 10 at an angle from the vertical direction. In the embodiment, exemplarily, if the inclination angle θ1 is set to 16 degrees or more, the first inclined surface 40a of the spacer member 40 can be prevented from being visually recognized, including a case in which the viewer views video on the video display section 10 at an angle from the vertical direction.

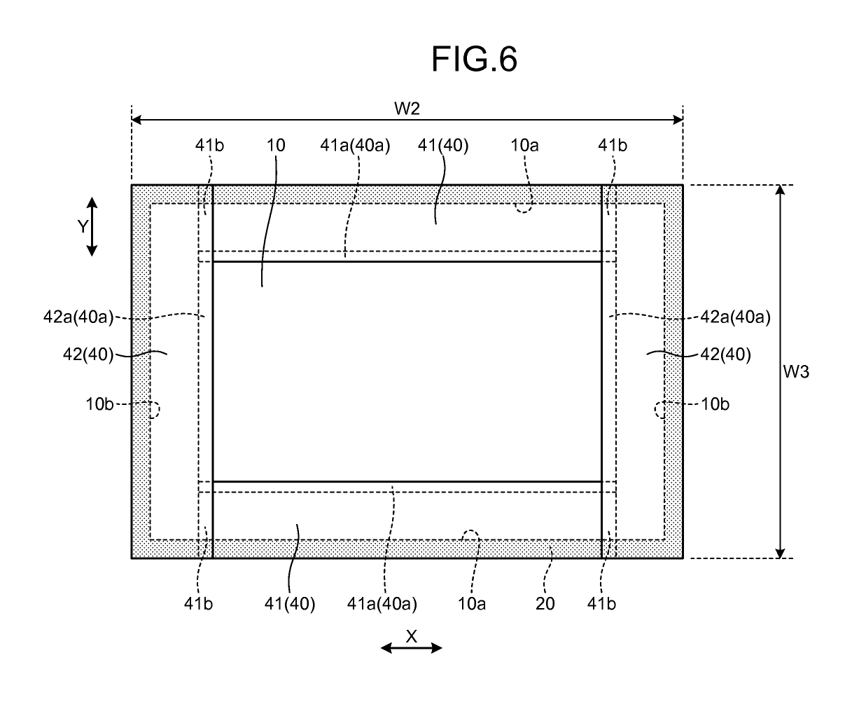

An exemplary configuration (shape) of the spacer member 40 of the video display device 100 in the embodiment will be described in detail below with reference to FIGS. 6 to 12.

As illustrated in FIG. 6, the spacer member 40 is formed in a frame shape that corresponds to the frame section 20 surrounding the video display section 10. The spacer member 40 is configured to be dividable into a pair of first spacer members 41 and a pair of second spacer members 42. Specifically, the first spacer members 41 are provided in association with the long sides 10a of the video display section 10, and the second spacer members 42 are provided in association with the short sides 10b of the video display section 10. Exemplarily, unlike a configuration in which the spacer member 40 is an integrated frame-shaped member, the foregoing configuration allows the spacer member 40 to be easily formed into a frame shape with the first spacer members 41 and the second spacer members 42 that can be easily formed through molding.

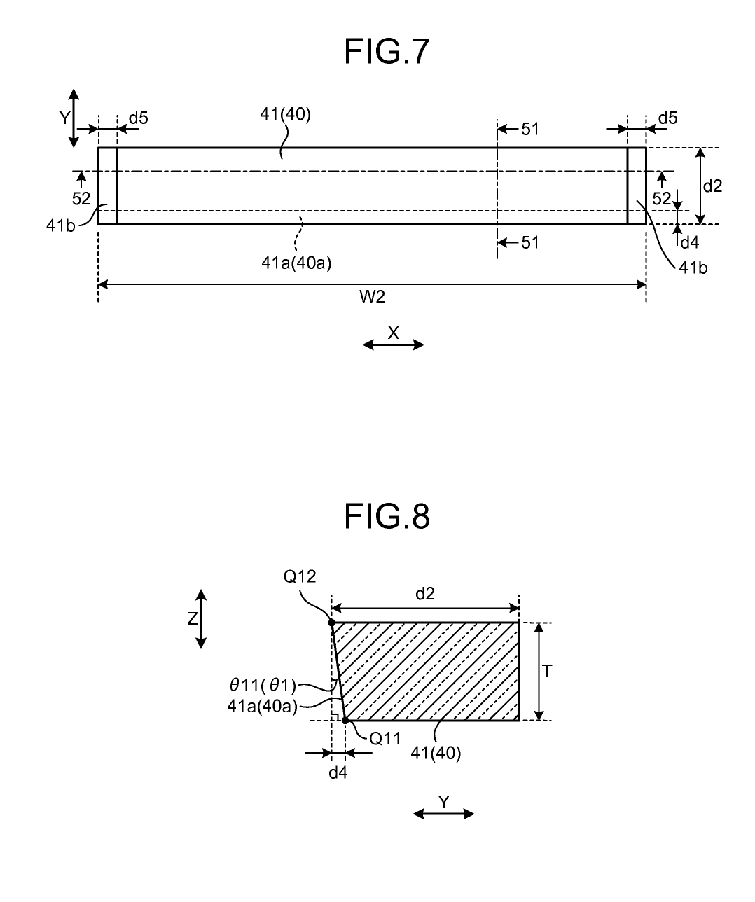

As illustrated in FIGS. 6 and 7, the first spacer members 41 are configured to extend in a direction in which the long sides 10a of the video display section 10 extend (X direction). As illustrated in FIGS. 6 and 10, the second spacer members 42 are configured to extend in a direction in which the short sides 10b of the video display section 10 extend (Y direction). It is here noted that a length W2 of the first spacer members 41 along the X direction is set to be longer than a length W3 of the second spacer members 42 along the Y direction.

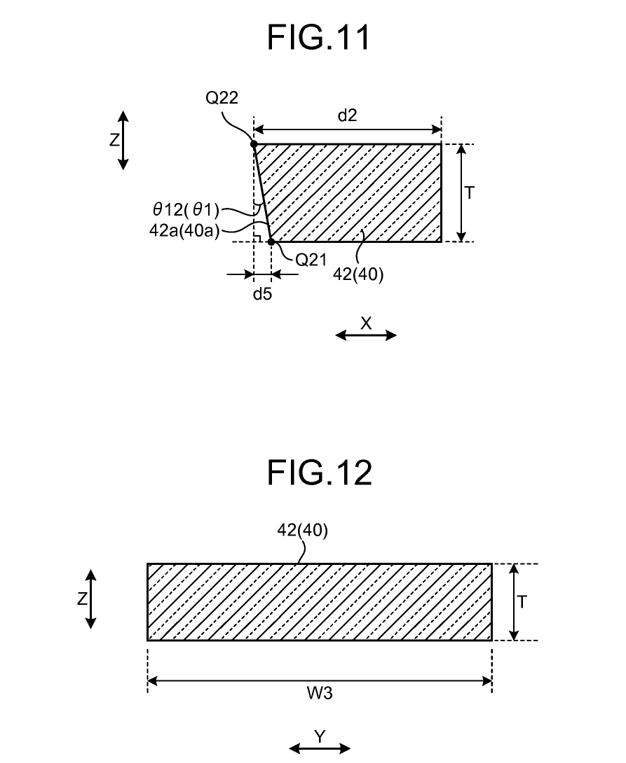

As illustrated in FIGS. 6 and 8, the first spacer members 41 of the spacer member 40 each have a first inclined surface 41a as the first inclined surface 40a mentioned earlier, the first inclined surface 41a being formed on inner surfaces of the first spacer members 41 on the side opposite to the frame section 20. As illustrated in FIGS. 6 and 11, the second spacer members 42 of the spacer member 40 each have a first inclined surface 42a as the first inclined surface 40a mentioned earlier, the first inclined surface 42a being formed on inner surfaces of the second spacer members 42 on the side opposite to the frame section 20.

As described earlier, with a video display device that displays video having an aspect ratio of 16:9, generally, the angle of view in the horizontal direction is about ±16 degrees, while that in the vertical direction is about ±9 degrees. Thus, in the embodiment, an inclination angle θ11 (see FIG. 8) is set to be smaller than an inclination angle θ12 (see FIG. 11). The inclination angle θ11 is an inclination angle of the first inclined surface 41a of each of the first spacer members 41 provided on both sides in the vertical direction (Y direction). The inclination angle θ12 is an inclination angle of the first inclined surface 42a of each of the second spacer members 42 provided on both sides in the horizontal direction (X direction).

That is, in the embodiment, a width d4 is set to be smaller than a width d5. The width d4 is a width in the Y direction between both ends of the first inclined surface 41a in the Z direction illustrated in FIG. 8 (see points Q11 and Q12). The width d5 is a width in the X direction between both ends of the first inclined surface 42a in the Z direction illustrated in FIG. 11 (see points Q21 and Q22). As described above, a viewing angle in the Y direction when the viewer views the video display device 100 is smaller than a viewing angle in the X direction. Thus, exemplarily, the foregoing setting allows the first inclined surface 41a of the first spacer member 41 and the first inclined surface 42a of the second spacer member 42 to be effectively prevented from being visually recognized by the viewer.

Referring to FIG. 6, the second spacer members 42 are provided so as to extend in the Y direction between upper ends and lower ends of the video display section 10 and the frame section 20, and to cover the upper ends and the lower ends of the video display section 10 and the frame section 20. The first spacer members 41 are provided so as to extend in the X direction between the pair of second spacer members 42.

As illustrated in FIGS. 6, 7, and 9, the first spacer member 41 has second inclined surfaces 41b that correspond to first inclined surfaces 42a of the second spacer members 42, the second inclined surfaces 41b being formed on both ends of the first spacer member 41 on the sides adjacent to the second spacer members 42 (both ends in the X direction) . The second inclined surface 41b has the same inclination angle θ12 as that of the first inclined surface 42a of the second spacer member 42. This arrangement, exemplarily, allows the second inclined surfaces 41b formed on the ends of the first spacer member 41 and the first inclined surfaces 42a of the second spacer members 42 to be brought into abutment with each other, which enables the first spacer members 41 and the second spacer members 42 to be connected to each other without any gap therebetween. It is noted that, in the embodiment, as illustrated in FIGS. 6, 10, and 12, no inclined surfaces as those of the second inclined surfaces 41b of the first spacer members 41 are formed on both ends of the second spacer members 42 (both ends in the Y direction).

In the embodiment, a thickness of the spacer member 40 is set so that video output to the video display section 10 and virtual video displayed enlarged by the optical element 30 are positioned on a single plane. The video output to the video display section 10 is video output to the normal area R1 and the reduction area R2 illustrated in FIG. 5. The virtual video displayed enlarged by the optical element is the virtual video V1 and V2 illustrated in FIG. 5.

Assuming that T is the thickness of the spacer member 40, the following describes a relational expression satisfied by the thickness T.

As illustrated in expression (4) mentioned earlier, letting m be the magnification of the optical element 30, expression (10) below holds between the distance B at which the virtual video is visually recognized and the distance A between the video display section 10 and the optical element 30.

B=m×A (10)

Additionally, letting n be the refractive index of the spacer member 40, the thickness T of the spacer member 40 is given by expression (11) below based on the distance A.

T=n×A (11)

From expressions (10) and (11) above, if the magnification m of the optical element 30 is equal to the refractive index n of the spacer member 40, the distance B at which the virtual video is visually recognized is equal to the thickness T of the spacer member 40. That is, the video output to the video display section 10 and the virtual video displayed enlarged by the optical element 30 are positioned on the single plane.

From expression (3) above, the distance A between the video display section 10 and the optical element 30 is given by expression (12) below based on the focal distance f of the optical element 30.

A=f(1/m−1) (12)

From expressions (11) and (12) above, the thickness T of the spacer member 40 is given by expression (13) below based on the focal distance f of the optical element 30.

T=n×f(1/m−1) (13)

If the magnification m of the optical element 30 is equal to the refractive index n of the spacer member 40, expression (13) above is rewritten in expression (14) below.

T=f(n−1) (14)

If the thickness T of the spacer member 40 is set so as to satisfy expression (14) above, exemplarily, the video output to the video display section 10 and the virtual video displayed enlarged by the optical element 30 can be positioned on the single plane, thereby the viewer can visually recognize the defect-free video without having a sense of discomfort.

As described heretofore, in the embodiment, the spacer member 40 is provided between the video display section 10 (the frame section 20) and the optical element 30. The spacer member 40 comprises an inner surface positioned between the optical element 30 and the video display section 10. The inner surface is provided with the first inclined surface 40a inclined toward the frame section 20 side more on the video display section 10 side than on the optical element 30 side. Thus, the spacer member 40 can be prevented from being visually recognized by the viewer because the first inclined surface is formed on the inner surface of the spacer member, exemplarily.

For example, the embodiment has been described as a technology to the tiling display comprising four video display devices. The technology of the embodiment is nonetheless applicable to a video display device used as a single unit. The technology of the embodiment is also applicable to a tiling display comprising two or more, but three or less, video display devices and a tiling display comprising five or more video display devices.

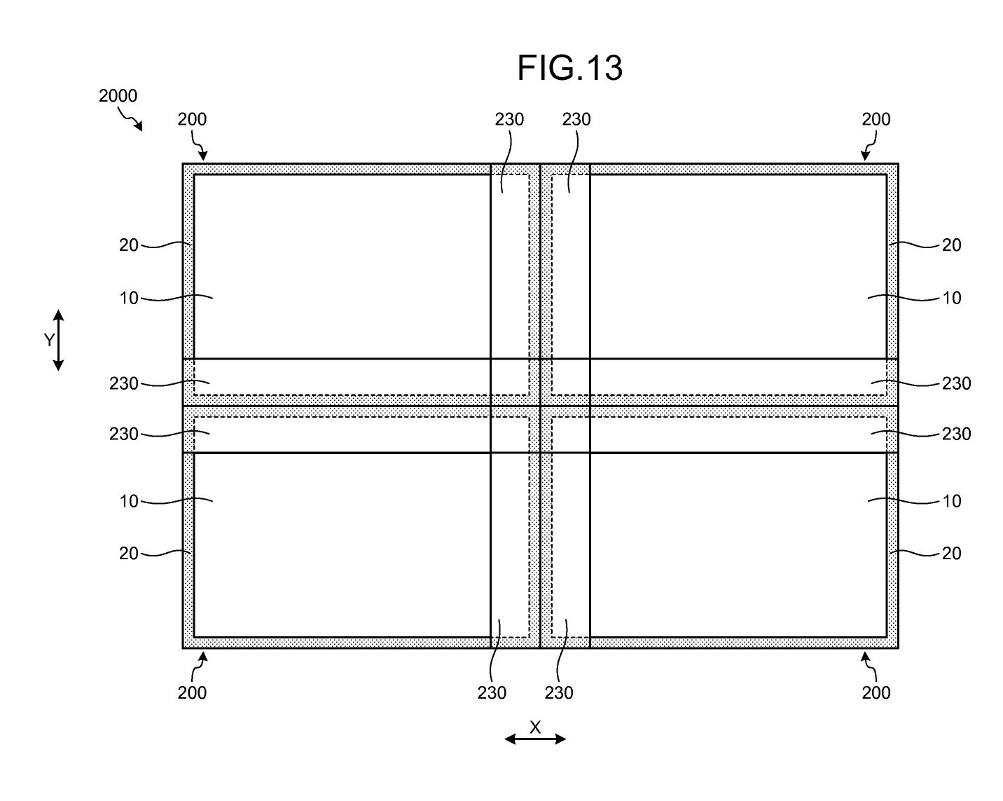

Additionally, the embodiment has been described for an exemplary case in which the optical element is provided on each of all four sides of each of the four video display devices. However, in another embodiment as a first modification illustrated in FIG. 13, an optical element 230 may be provided only at a boundary between two adjoining video display devices 200 of a tiling display 2000 comprising four video display devices 200. In the first modification, frame sections 20 provided at the inner cross-shaped portion of the tiling display 2000 are less easily visually recognized, while the frame sections 20 provided at an outer quadrilateral portion of the tiling display 2000 are easily visually recognized.

Additionally, the embodiment has been described for an exemplary case in which the optical element and the spacer member are formed separately from each other. In another embodiment, however, the optical element and the spacer member may be formed integrated with each other.

Additionally, the embodiment has been described for an exemplary case in which the spacer member is configured to be dividable into the first spacer member and the second spacer member. In another embodiment, however, spacer member may even comprise a single inseparable member.

Additionally, the embodiment has been described for an exemplary case in which the first inclined surface of the first spacer member has an inclination angle set to be smaller than that of the first inclined surface of the second spacer member. In another embodiment, however, the first inclined surface of the first spacer member may still have an inclination angle set to be equal to that of the first inclined surface of the second spacer member.

Additionally, the embodiment has been described for an exemplary case in which the first spacer member has the second inclined surfaces formed on its ends, and the second inclined surfaces and the first inclined surfaces of the second spacer members are brought into abutment with each other. In another embodiment, however, the second spacer member may have the second inclined surfaces formed on its ends, and the second inclined surfaces and the first inclined surfaces of the first spacer members may be brought into abutment with each other.

Additionally, the embodiment has been described for an exemplary case in which the optical element comprises the linear lenses and the circular lenses combined with each other. Any other optical system may nonetheless be used in the embodiment.

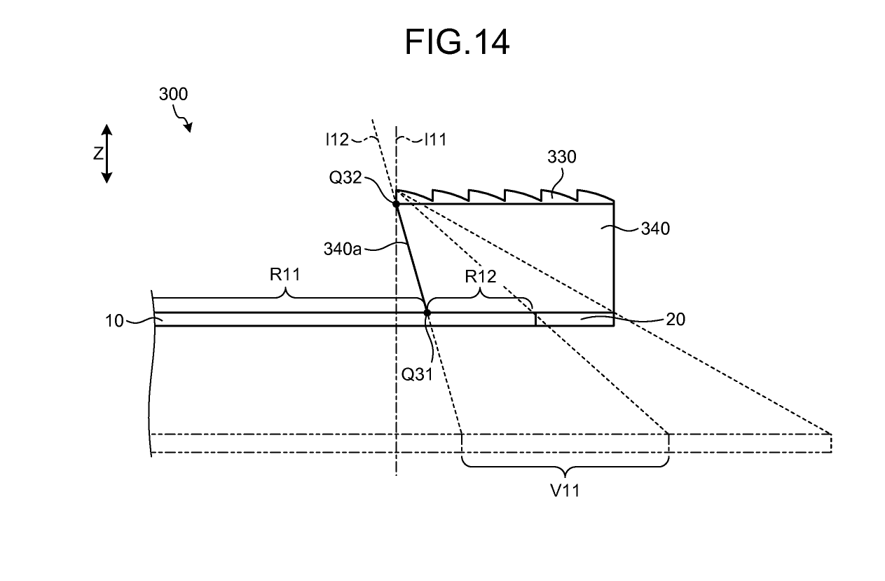

Additionally, the embodiment has been described for an exemplary case in which the optical element extends on both sides (the frame section side and the side opposite to the frame section) relative to the optical axis. However, in another embodiment as a second modification illustrated in FIG. 14, an optical element 330 of a display device 300 may comprise no portion that extends on the side opposite to the frame section 20 relative to an optical axis I11.

In the second modification illustrated in FIG. 14, similarly to the embodiment described above, the frame section 20 overlaps virtual video V11 that is formed by a reduced image output to a reduction area R12 being enlarged with the optical element 330, so that the frame section 20 can be prevented from being visually recognized by the viewer. In addition, in the second modification, similarly to the embodiment described above, a spacer member 340 has an inner surface on the side opposite to the frame section 20, the inner surface being formed by an inclined surface 340a that is aligned with an optical path (see a straight line 112) connecting an end of the reduction area R12 (see a point Q31) and an end of the optical element 330 (see a point Q32). The point Q31 indicates the end of the reduction area R12 on the side opposite to the frame section 20 (a boundary relative to a normal area R11). The point Q32 indicates the end of the optical element 330 on the side opposite to the frame section 20. Thus, according to the second modification illustrated in FIG. 14, the spacer member 340 can be prevented from being visually recognized by the viewer.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A video display device comprising:
a display comprising a video display section on which video is displayed and a frame section provided along an outer edge of the video display section;
an optical element provided so as to cover the frame section and an outer edge area provided on the outer edge side within the video display section, the optical element configured to enlarge video output from the outer edge area onto the frame section side; and
a spacer member provided between the video display section and the optical element and between the frame section and the optical element, the spacer member comprising an inner surface positioned between the optical element and the video display section, the inner surface being provided with a first inclined surface inclined toward the frame section more on the video display section side than the optical element side.

2. The video display device of claim 1, wherein the first inclined surface is provided so as to be inclined at an inclination angle so as to be aligned with an optical path connecting an end of the optical element on the inner surface side and an end of the outer edge area on the inner surface side.

3. The video display device of claim 1, wherein the first inclined surface is provided so as to extend, on the inner surface of the spacer member, from an end on the optical element side to an end on the video display section side.

4. The video display device of claim 1, wherein
the video display section and the optical element are provided so as to extend in parallel with each other,
the video display section is formed in a rectangular shape including long sides and short sides,
the spacer member comprises first spacer members and second spacer members in association with the long sides and the short sides of the video display section, respectively, and
the first inclined surface of each of the first spacer members has an inclination angle relative to a direction set to be equal to or smaller than an inclination angle of the first inclined surface of each of the second spacer members relative to the direction, the direction being orthogonal to the video display section and the optical element.

5. The video display device of claim 1, wherein
the video display section is formed in a quadrilateral shape including first sides extending in a first direction and second sides extending in a second direction crossing the first direction, and
the spacer member is configured so as to be dividable into first spacer members provided in association with the first sides and second spacer members provided in association with the second sides.

6. The video display device of claim 5, wherein
the first spacer members are provided so as to extend between a pair of the second spacer members, and
an end of each of the first spacer members on the second spacer member side is provided with a second inclined surface and inclined in association with the first inclined surface of the second spacer members.

7. The video display device of claim 1, wherein a thickness of the spacer member is set so that video output to the video display section and virtual video displayed enlarged by the optical element are positioned on a single plane.

8. The video display device of claim 1, wherein
the video display section and the optical element are provided so as to extend in parallel with each other, and
the inclination angle of the first inclined surface relative to the direction orthogonal to the optical element and the video display section is set to be equal to or greater than 9 degrees.

9. The video display device of claim 1, wherein the video display section is configured to output video reduced at a reduction ratio compatible with a magnification of the optical element to the outer edge area.
